(19) United States
(12) Patent Application Publication
(10) Pub. No.: US 2009/0184062 A1
(43) Pub. Date: Jul. 23, 2009

(54) METHOD FOR INHIBITING BIOFILM GROWTH

(75) Inventor: Stanley R. Pickens, Monroeville, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., CLEVELAND, OH (US)

(21) Appl. No.: 12/017,201

(22) Filed: Jan. 21, 2008

(51) Int. Cl. C02F 1/50

(52) U.S. Cl. 210/756; 210/754; 210/764

(57) ABSTRACT

The growth of biofilm present in open recirculating water systems is inhibited by introducing into the water comprising such a water system (a) a source of free halogen, e.g. e chlorine and (b) a source of di(lower alkyl) substituted-2-oxazolidinone, the mole ratio of (a) to (b) and the combined amount of (a) and (b) being sufficient to at least inhibit the growth of the biofilm, e.g., the bacteria comprising the biofilm, the source of free available halogen being present in less than biostatic amounts.

### FIELD OF THE INVENTION

The present invention relates to a method for inhibiting the growth of biofilm in recirculating water systems, e.g., recirculating industrial cooling water systems. In particular, the present invention relates to a method for inhibiting the growth of biofilm in open recirculating water systems wherein the water in said system is substantially free of organic matter that fosters the growth of biofilm-producing microorganisms.

### BACKGROUND OF THE INVENTION

Most current biocides have been developed for the control of planktonic (free floating dispersed) bacteria in recirculating water systems. Such biocides are generally used at low concentrations to act only bacteriostatically on planktonic bacteria. At low concentrations, most currently used biocides are not effective against biofilms, which are produced by microorganisms that grow as ensheathed filamentous microcolonies that are permanently attached (sessile) to solid surfaces of the recirculating water system. These biofilms comprise a complex dynamic organic polymer structure, and can cause a significant economic impact in recirculating water systems because of energy losses due, in part, to increased fluid frictional resistance and increased heat transfer resistance. The adverse effect of biofilms in recirculating water systems has become known in the industry as biofouling.

The presence of sessile biofilm on internal surfaces comprising a recirculating water system causes significant operational difficulties by causing damage to equipment comprising the recirculating water system through corrosion, down time and decreased energy efficiency due to the increased pressure drop in water pipe lines and a lower heat transfer rate. The loss in the heat transfer rate is caused because the thermal conductivity of the biofilm is significantly less than that of metal heat transfer surface materials. Other major negative economic impacts of biofouling within recirculating water systems include, but are not limited to, increased capital costs for excess equipment capacity, premature replacement of equipment, and unscheduled down time to clear fouled equipment.

To be at least biostatically effective against biofilms, a biocide must traverse the outer membrane (sheath) of the microorganism comprising the biofilm. Generally, currently available low cost biocides are not effective to control the growth of biofilms when used in concentrations used to control planktonic bacteria. Biofilm producing organisms, e.g., Sphaerotilus natans, are typically rod-shaped organisms that are enclosed in long hyaline sheaths. These organisms form sedentary (sessile) ensheathed filamentous microcolonies, which grow on the surfaces of equipment comprising the recirculating water system, e.g., heat exchange surfaces.

The sheath or matrix formed by biofilm producing organisms provide them with an inherent resistance to biocides, particularly oxidizing biocides. It has been suggested that when used in antibacterial concentrations generally used to control planktonic bacteria, oxidizing biocides, such as chlorine or hypochlorous acid, do not penetrate the sheath layer sufficiently to effectively inhibit or kill the biofilm-producing organism. This is reported to be caused by the diffusional resistance of the biofilm matrix (especially in the deeper, dormant layers of the matrix), and because of the tendency of the excreted glycocalyx slime to consume oxidizing biocides. While high (bacteriocidal) doses of an oxidizing biocide, e.g., chlorine, could be used to kill the biofilm-producing organism, the use of such quantities of oxidizing biocides cause other operational problems, such as corrosion of the equipment comprising the recirculating water system.

### BRIEF SUMMARY OF THE INVENTION

In accordance with the present invention, there is described a method of inhibiting the growth of biofilm in open recirculating water systems, wherein the water in said system is substantially free of organic matter that fosters the growth of biofilm-producing microorganisms. In accordance with a non-limiting embodiment of the method of the present invention, the growth of an objectionable biofilm in the water system is inhibited by providing in said recirculating water (a) a source of free available halogen and (b) a source of di(lower alkyl)-substituted-2-oxazolidinone, the mole ratio of (a) to (b) and the combined amount of (a) and (b) provided in said recirculating water being sufficient to at least inhibit growth of the biofilm, said source of free available halogen itself being present in amounts that are less than biostatic to the biofilm. In accordance with a further non-limiting embodiment of the present invention, the amounts of (a) and (b) are sufficient to provide at least a biostatic amount of 3-halo-di(lower alkyl)-substituted-2-oxazolidinone. In another non-limiting embodiment of the present invention, the amounts of (a) and (b) present in said recirculating water are sufficient to provide a biocidal amount of 3-halo-di(lower alkyl)-substituted-2-oxazolidinone.

In a still further non-limiting embodiment of the present invention, 3-halo-di(lower alkyl)-substituted-2-oxazolidinione is supplied to the recirculating water system, e.g., to the recirculating water, in an amount sufficient to inhibit the growth of the biofilm, e.g., in at least biostatic amounts. In this later embodiment, the 3-halo-di(lower alkyl)-substituted-2-oxazolidinone is pre-formed on-site or off-site and then charged to the water comprising the recirculating water system. In a non-limiting embodiment of the present invention, the 3-halo-di(lower alkyl)-substituted-2-oxazolidinone is a 3-chloro-di(lower alkyl)-substituted-2-oxazolidinone. In a further non-limiting embodiment, the 3-chloro-di(lower alkyl)-substituted-2-oxazolidinone is 3-chloro-4,4-dimethyl-2-oxazolidinone.

### DETAILED DESCRIPTION OF THE INVENTION

For purposes of this specification (other than in the operating examples) or unless otherwise indicated, all numbers expressing quantities and ranges of ingredients, reaction conditions, etc used in the following description and claims are to be understood as modified in all instances by the term “about”. Accordingly, unless indicated to the contrary, numerical parameters set forth in this specification and the claims attached hereto are approximations that may vary depending upon the results to be obtained by the method of the present invention. At the very least, and not as an attempt to limit the application of the doctrine of equivalents to the scope of the attached claims, each numerical parameter should at least be construed in light of the number of reported significant digits and by applying ordinary rounding techniques. Further, as used in this specification and the appended claims, the singular forms “a”, “an”, “said” and “the” are intended to include plural referents, unless expressly and unequivocally limited to one referent.

Notwithstanding that the numerical ranges and parameters setting forth the broad scope of the invention are approximations, numerical values set forth in specific examples are reported as precisely as possible. Any numerical value, however, inherently contains certain errors necessarily resulting from the standard deviation found in their respective testing measurements. Also, it should be understood that any numerical range recited herein is intended to include all sub-ranges subsumed therein. For example, a range “1” to “10” is intended to include all sub-ranges between and including the recited minimum value of 1 and the recited maximum value of 10; namely, a range having a minimum value equal to or greater than 1 and a maximum value of equal to or less than 10. Because the disclosed ranges are continuous, they include every value between the minimum and maximum values. Unless expressly indicated otherwise, the various numerical ranges specified in this application are, as stated, approximations.

As used in the following description and claims, the following terms have the indicated meanings:

The term “biofilm” means a film formed by biological material, e.g., at least one microorganism, that comprises thin layers of ensheathed filamentous microbial colonies.

The term “biofouling” means the attachment of biofilm to solid surfaces in engineered recirculating water systems in amounts sufficient to cause an adverse economic effect, such as energy losses due to increased fluid frictional resistance, increased heat transfer resistance and/or microbial-induced corrosion of metal surfaces.

The term “industrial water system” means engineered recirculating water systems, which include but are not limited to, cooling water systems such as cooling tower systems, drinking water distribution systems, secondary oil recovery, metal working, food processing condensers and heat exchangers.

The term “lower alkyl” means a saturated hydrocarbon (either branched or straight chain) containing from 1 to 4 carbon atoms. Non-limiting examples of lower alkyl hydrocarbons include methyl, ethyl, n-propyl, isopropyl, isobutyl and n-butyl.

The word “open”, as used in connection with the term “open recirculating water system”, means that the system is open to the atmosphere, as contrasted with a closed system that is sealed and not open to the atmosphere.

The term “substantially free of organic matter”, as used in connection with the water comprising the recirculating water system, means that the recirculating water is substantially free of organic matter, such as polysaccharides, that fosters the growth of biofilm-producing organisms. The term “organic matter”, as used in the term “free of organic matter”, is not intended to include natural organic matter unintentionally entering an open recirculating water system; namely, organic debris such as, but not limited to, leaves, dust, pollen, insects and other such air-borne organic debris that may be present in the recirculating water because the system is open to the atmosphere. Hence, such debris is not included in the term “organic matter” in the phrase “substantially free of organic matter”.

The word “halogen”, as used in the term “free available halogen”, means bromine, chlorine and mixtures of chlorine and bromine.

The term “free available halogen”, e.g., free available chlorine, means halogen, e.g., chlorine, in the form of elemental halogen, hypohalous acid, e.g., hypochlorous acid (HOCl) or hypobromous acid (HOBr), or as the hypohalite ion, e.g., hypochlorite ion (ClO⁻) or hypobromite ion (BrO⁻).

In accordance with a non-limiting embodiment of the present invention, a source of free available halogen, e.g., chlorine or bromine, and a source of di(lower alkyl) substituted-2-oxazolidinone are provided to water comprising an open recirculating water system. The source of free available halogen can be any halogen-containing material (organic or inorganic) that when added to the water provides halogen in the form of elemental halogen, as hypohalous acid or as the hypohalite ion. Non-limiting examples of a source of free available halogen include alkali metal and alkaline earth metal hypohalites, e.g., lithium, sodium, potassium, calcium and magnesium hypochlorites or hypobromites, chlorine, bromine, bromine chloride, halogenated cyanurates, e.g., chlorinated isocyanurates, such as dichloroisocyanuric acid and its sodium and potassium salts, e.g., sodium dichliorocyanurate, trichlorocyanuric acid (often called trichlor) and its sodium and potassium salts, e.g., sodium trichlorocyanuric acid, and mixtures of a source of free available chlorine and sodium bromide. Mixtures of compatible sources of free available halogen may also be used, e.g., chlorine and sodium hypochlorite.

Di(lower alkyl)-substituted-2-oxazolidinones that can be used in the method of the present invention may be represented by the following graphic formula,

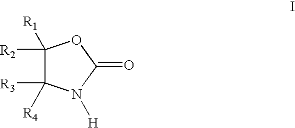

wherein the substituents R₁, R₂, R₃, and R₄ are each chosen from hydrogen and lower alkyl, provided that at least two of R₁, R₂, R₃, and R₄ are lower alkyl groups. In a further non-limiting embodiment, the lower alkyl group chosen for substituents R₁, R₂, R₃, and R₄ is the same, e.g., methyl.

In formula I, the ring members of the 2-oxazolidinones are numbered starting with the internal oxygen atom as number 1 and proceeding clockwise around the ring, e.g., the carbonyl carbon atom being in the 2 position, the nitrogen atom being in the 3 position, the carbon atom attached to the R₃ and R₄ substituents being in the 4 position and the carbon atom attached to the R₁ and R₂ substituents being in the 5 position. In a non-limiting embodiment, the di(lower alkyl) substituted-2-oxazolidinone is a 4,4-lower alkyl substituted-2-oxazolidinone. Non-limiting examples of di(lower alkyl) substituted-2-oxazolidinones corresponding to Formula I include: 4,4-dimethyl-2-oxazolidinone, 4-methyl-4-ethyl-2-oxazolidinone, 4,4-diethyl-2-oxazolidinone, 5,5-dimethyl-2-oxazolidinone, 5,5-diethyl-2-oxazolidinone, 5-methyl-5-ethyl-2-oxazolidinone, 4,5-dimethyl-2-oxazolidinone, 4-methyl-5-ethyl-2-oxazolidinone, 4-ethyl-5-methyl-2-oxazolidinone, 4-methyl-4-propyl-2-oxazolidinone, 4,4-dipropyl-2-oxazolidinone, and 4,4-dibutyl-2-oxazolidinone.

It has been reported that when di(lower allyl)-substituted-2-oxazolidinones and free available halogen, e.g., chlorine, are both present in an aqueous system, free available halogen combines with the 2-oxazolidinone to form in-situ 3-halo-di(lower alkyl)-2-oxazolidinone. See, for example, column 2, lines 22-30 of U.S. Pat. No. 4,927,546. The 3-halo-di(lower alkyl) substituted-2-oxazolidinone described herein is relatively stable in aqueous solution under conditions, e.g., temperature and pH, that generally exist in open recirculating water systems. In a non-limiting embodiment, the temperature of the water in an open recirculating water system is likely to be at ambient temperatures, e.g., temperatures between 5° C. and 50° C. In a non-limiting embodiment, the pH of water in an open recirculating water system is likely to be slightly alkaline, e.g. between 8 and 9.

The 3-halo-di(lower alkyl) substituted-2-oxazolidinone that is reported to be formed by the reaction of free available halogen with a di(lower alkyl) substituted-2-oxazolidinone may be represented by the following formula:

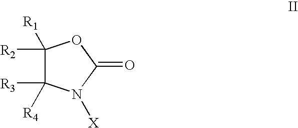

wherein X is chlorine or bromine, and R₁, R₂, R₃, and R₄ are as defined above with respect to formula I.

The amount of the source of free available halogen and the amount of the source of di(lower alkyl) substituted-2-oxazolidinone provided to the water comprising the water recirculating system can vary widely. However, it is contemplated that the mole ratio and amounts of each of those materials are provided to the water system such that the combined amount of these materials is sufficient to at least inhibit or control, e.g., limit, the growth of microorganisms comprising the biofilm, e.g., inhibit the growth of the biofilm, thereby to inhibit biofouling within the system. In a non-limiting embodiment, the amount of the source of free available halogen itself provided to the water comprising the water recirculating system is less than biostatic or biocidal in regard to the biofilm-producing microorganism(s). In a non-limiting embodiment, an amount of each of the source of free available halogen and di(lower alkyl) substituted-2-oxazolidinone is added so that the combined amount of such materials is sufficient to at least biostatically inhibit the growth of microorganisms comprising the biofilm, i.e., a biostatic amount. In a further non-limiting embodiment, the combined amount of each of such materials is sufficient to biocidally control the growth of microorganisms comprising the biofilm, i.e., at least a biocidal amount.

In an alternate non-limiting embodiment of the present invention, the source of free available halogen and source of (di)lower alkyl) substituted-2-oxazolidinone are supplied to the water comprising the recirculating water system in amounts sufficient to form in-situ at least a biostatic amount of 3-halo-di(lower alkyl) substituted-2-oxazolidinone in the water. In a further non-limiting embodiment of the present invention, the source of free available halogen and source of (di)lower alkyl) substituted-2-oxazolidinone are added to the water comprising the recirculating water system in amounts sufficient to form in-situ a biocidal amount of 3-halo-di(lower alkyl) substituted-2-oxazolidinone in the water.

In a non-limiting embodiment of the present invention, the source of free available halogen and the source of di(lower alkyl) substituted-2-oxazolidinone are provided to the water comprising the water recirculating system in amounts such that the mole ratio of free available halogen and di(lower alkyl) substituted-2-oxazolidinone vary from 0.1:1 to 10:1. In alternate non-limiting embodiments, the mole ratio of free available halogen to di(lower alkyl) substituted-2-oxazolidinone varies from 0.5:1 to 5:1, e.g., 0.8:1 to 1.2:1. In a further non-limiting embodiment of the present invention, the source of free available halogen and the source of di(lower alkyl) substituted-2-oxazolidinone are provided to the water comprising the water recirculating system in stoichiometric amounts, e.g., amounts wherein the mole ratio in the water system of free available halogen (from the source of free available halogen) and di(lower alkyl) substituted-2-oxazolidinone is approximately 1:1. The mole ratio of free available halogen to di(lower alkyl) substituted-2-oxazolidinone can vary between any of the stated values, including the recited values.

In a further non-limiting embodiment of the present invention, pre-formed 3-halo-di(lower alkyl)-substituted-2-oxazolidinone is supplied to the water comprising the water recirculating system. In a non-limiting embodiment of the present invention, the amount of pre-formed 3-halo-di(lower alkyl)-substituted-2-oxazolidinone added to the water comprising the water recirculating system is in amounts comprising at least a biostatic amount, e.g., an amount sufficient to at least inhibit the growth of the microorganism(s) producing the biofilm, thereby to inhibit biofouling within the water system. In another non-limiting embodiment, the amount of pre-formed 3-halo-di(lower alkyl)-substituted-2-oxazolidinone added to the water is a biocidal amount, e.g., an amount sufficient to kill the microorganism(s) that produces the biofilm.

In a non-limiting embodiment of the present invention, 3-halo-di(lower alkyl)-substituted-2-oxazolidinone is added to the water (or is present in the water when formed in-situ) comprising the water recirculating system in amounts of from 0.1 to 100 parts per million parts of water (ppm). In alternate non-limiting embodiments of the present invention, 3-halo-di(lower alkyl)-substituted-2-oxazolidinone is added to the water (or is present in the water when formed in-situ) in amounts of from 0.5 to 50 ppm, e.g., from 1 to 5 ppm. The amount of 3-halo-di(lower alkyl)-substituted-2-oxazolidinone added to the water (or is present in the water when formed in-situ) comprising the water recirculating system can vary between any of the stated values, including the recited values.

3-halo-di(lower alkyl)-substituted-2-oxazolidinones can be prepared by methods known in the art, e.g., by bringing a source of free available halogen, e.g., chlorine, and the desired 2-oxazolidinone together in an aqueous medium. In one non-limiting embodiment, the reagents are reacted together at temperatures and under conditions to minimize hydrolysis of the halogenated 2-oxazolidinone. Reaction temperatures can vary. In a non-limiting embodiment, reaction temperatures are within the range of 0° C. to 10° C. Alternatively, 3-halo-di(lower alkyl) substituted-2-oxazolidinone can be prepared by a transhalogenation process involving reaction of an unhalogenated 2-oxazolidinone with a halogenated isocyanuric acid, e.g., trichloroisocyanuric acid, in an inert organic solvent, e.g., chloroform, methylene chloride or ethylene chloride, at ambient temperatures. See, for example, column 2, line 65 through column 3, line 25 of U.S. Pat. No. 4,000,293, which disclosure is incorporated herein by reference.

Di(lower alkyl) substituted-2-oxazolidinone can be prepared also by reaction of the corresponding alkanolamine with a di(lower alkyl) carbonate, such as diethyl carbonate, in the presence of strong base such as an alkali metal alkoxides, e.g., sodium methoxide. The reaction can be carried out by heating the reactants above the boiling temperature of the lower alkanol produced in the reaction, which is removed from the reaction as it forms. Alternatively, di(lower alkyl) substituted-2-oxazolidinones can be prepared by reacting the corresponding alkanolamine with urea at an elevated temperature, e.g., temperatures in the range of 150° C. to 250° C. The alkanolamines are a generally known class of compounds. See, for example, column 3, lines 26 to 62 of U.S. Pat. No. 4,000,293, which disclosure is incorporated herein by reference.

In accordance with an embodiment of the present invention, the water comprising the recirculating water system is substantially free of organic matter, e.g., polysaccharide, that fosters the growth of biofilm-producing microorganisms. In alternate non-limiting embodiments of the present invention, the amount of organic matter present in the water is less than 0.1 weight percent, e.g., less than 0.05 weight percent.

The invention is further described in conjunction with the following examples, which are to be considered as illustrative rather than limiting, and in which all parts are by weight and all percentages are weight percentages unless otherwise specified.

In the following examples, the sheathed filamentous bacterium Sphaerotilus natans (ATCC 15291) was used. A freeze-dried sample of the bacterium was obtained from the American Type Culture Collection (ATCC, Rockville, Md.). ATCC growth medium (CYGA #1103 broth) was prepared by dissolving (per liter of tap water): 5 grams casitone (pancreatic digest of casein, Difco #225930), which is available from Voight Global Distributions, Inc., Lawrence, Kans.; 10 grams of glycerol; and 1 gram of yeast extract. The growth medium was sterilized at 120° C. for 15 minutes. The sample of Sphaerotilus natans obtained from ATCC was cultured in the CYGA growth medium and transferred to agar plates prepared from CYGA medium plus 1.5 weight percent agar. The agar plates were incubated at 30° C. The bacterium from these agar plates was transferred (subcultured) every few weeks to fresh agar plates to maintain the viability of the microorganism.

3-chloro-4,4-dimethyl-2-oxazolidinone (DMO-Cl) reagent was prepared by manually mixing a selected amount of 4,4-dimethyl-2-oxazolidinone (DMO) and a hypochlorite-containing stock solution in an Erlenmeyer flask, and allowing the mixture to stand for 8-10 hours at room temperature (about 23° C.) prior to use in the experiments. The hypochlorite-containing stock solution was prepared by dissolving calcium hypochlorite in deionized water in an Erlenmeyer flask. The amount of calcium hypochlorite used provided a hypochlorite concentration of approximately 1000 mg/L. The DMO used was Sustains Summer Shield (approximately 17.5 wt. % DMO, density of 1.14 g/mL), which is available from PPG Industries, Inc. The mixture was diluted to the desired concentration with sterile tap water before use in the experiments. Sterile tap water used in the experiments was prepared by autoclaving tap water at 120° C. for 15 minutes. The sterile tap water contained no measurable level of chlorine.

### EXAMPLE 1

A loop full of Sphaerotilus natans (S. Natans) from an Agar plate containing the S. Natans culture was inoculated in 150 mL of CYGA #1103 growth medium and agitated in a temperature-controlled shaker at 30° C. and 150 rpm for 20 hours to prepare a pre-culture. Five (5) mL of this pre-culture were inoculated into each of a series of 250 mL Erlenmeyer flasks containing 150 mL of CYGA growth medium for batch cultivation of the S. Natans. The bacterium were cultivated at 30° C. for 96 hours on a rotary shaker at 150 rpm. At these conditions, a biofilm layer approximately 2-3 mm high formed on the inside wall of each of the Erlenmeyer flasks near the liquid surface. Approximately 50 to 75 percent of the liquid growth medium in the flasks was carefully decanted, leaving the biofilm layer intact. The decanted liquid growth medium was discarded.

For the control, sterile tap water was added to an Erlenmeyer flask. In other tests (as shown in Table I), various levels of hypochlorous acid (HOCl) or 3-chloro-4,4-dimethyl-2-oxazolidinone (DMO-Cl) were added to an Erlenmeyer flask. The amount of tap water used was approximately equal to the volume of decanted growth medium. The flasks were placed on a temperature controlled rotary shaker (30° C., 150 rpm) for 60 minutes. Total chlorine and free chlorine levels in the liquid medium in the flasks were measured at the beginning and at the end of the 60 minute contact time. At the end of the 60 minute contact time, the biofilm ring was carefully scraped from the flask surface and added to the liquid medium in the flask to ensure that the liquid medium contained the entire biofilm population for enumeration. The liquid in the flask was vigorously agitated to uniformly disperse the organisms. The liquid in the flask was sampled and serially diluted in sterile tap water for agar plating to enumerate the surviving organisms. Agar plating was performed in duplicate and the number of microorganism colonies counted after 48 hours of growth at approximately 30° C. Results are tabulated in Table I.

TABLE I

| | | Chlorine (mg/L) | | | | |
|---|---|---|---|---|---|---|
| | Test | | FC² | End³ | | Final Cell |
| Group | Medium | TC¹ (I) | (I) | TC | End³ FC | Count⁴ |
| A | Water Control | 0 | 0 | 0 | 0 | 2.7 × 10⁴ |
| B | HOCl⁵ | 1.1 | 0.7 | 0.3 | 0 | 1.9 × 10⁴ |
| C | DMO-Cl⁶ | 1.04 | 0.2 | 0.4 | 0.1 | 25^{a} |
| D | HOCl | 5.4 | 5.0 | 3.1 | 1.6 | 0 |
| E | DMO-Cl⁶ | 5.4 | 0.4 | 4.7 | 0.2 | 0 |

¹TC (I) Total Chlorine (Initial), expressed as mg/L Cl₂; Measured using a Hach DPD test kit method.
²FC (I) Free Chlorine (Initial), expressed as mg/L Cl₂; Measured using a Hach DPD test kit method.
³End (after one hour) values of total and free chlorine; expressed as mg/L Cl₂; Measured using a Hach DPD test kit method.
⁴Average of duplicates; Measured in cfu/mL (colony forming units per milliliter).
⁵Hypochlorous Acid (A hypochlorite solution prepared by dissolving calcium hypochlorite in tap water.)
⁶DMO-Cl (3-Chloro-4,4-dimethyl-2-oxazolidinone); Prepared using 50 μL/L Sustain ® Summer Shield, which contains approximately 10 mg/L of DMO.
^{a}No viable cells found in one of the replicates.

The results of Table I show that DMO-Cl has a significant effect on an existing S. Natans biofilm, achieving a minimum 3 log reduction in viable cell numbers after 60 minutes contact time. The results of Table I show also that a total chlorine level of approximately 5 mg/L appeared to be completely biocidal in this test method regardless of the presence of DMO-Cl.

### EXAMPLE 2

The procedure of Example 1 was followed except that the concentration of DMO-Cl was varied from 15 μL/L to 60 μL/L, and the contact time was 30 minutes to allow a better opportunity for survival and detection of the S. Natans microorganism. Results are tabulated in Table II. Symbols and footnotes used in Table II that are the same as those found in Table I have the same meaning.

TABLE II
Chlorine (mg/L)

| | | Chlorine (mg/L) | | | | |
|---|---|---|---|---|---|---|
| | Test | | FC² | End³ | | Final Cell |
| Group | Medium | TC¹ (I) | (I) | TC | End³ FC | Count⁴ |
| A | Water Control | 0 | 0 | 0 | 0 | 3.1 × 10⁵ |
| B | HOCl⁵ | 1.1 | 0.93 | 0.31 | 0.1 | 2.3 × 10⁴ |
| C | DMO-Cl⁷ | 1.2 | 0.05 | 0.52 | 0.05 | 2.1 × 10⁴ |
| D | DMO-Cl⁸ | 1.18 | 0.12 | 0.47 | 0.07 | 1.6 × 10⁴ |
| E | DMO-Cl⁹ | 1.19 | 0.15 | 0.41 | 0 | 0 |

⁷DMO-Cl (3-Chloro-4,4-dimethyl-2-oxazolidinone); Prepared using 15 μL/L Sustain ® Summer Shield, which contains approximately 3 mg/L of DMO.
⁸DMO-Cl (3-Chloro-4,4-dimethyl-2-oxazolidinone); Prepared using 30 μL/L Sustain ® Summer Shield, which contains approximately 6 mg/L of DMO.
⁹DMO-Cl (3-Chloro-4,4-dimethyl-2-oxazolidinone); Prepared using 60 μL/L Sustain ® Summer Shield, which contains approximately 12 mg/L of DMO.

The data of Tables I and II show that complete control of a biofilm produced by the microorganism S. Natans is achieved by the use of between 50 and 60 μL/L of DMO with a source of free available chlorine, and at contact times of between 30 and 60 minutes.

Although the present invention has been described with reference to specific details of certain embodiments thereof, it is not intended that such details should be regarded as limitations upon the scope of the invention except insofar as they are included in the accompanying claims.

What is claimed is:

1. A method of inhibiting the growth of biofilm in an open recirculating water system, wherein the water comprising said water system is substantially free of organic matter that fosters the growth of biofilm-producing microorganism, which method comprises providing in said recirculating water (a) a source of free available halogen and (b) a source of di(lower alkyl) substituted-2 oxazolidinone, the mole ratio of (a) to (b) and the combined amount of (a) and (b) being sufficient to at least inhibit growth of the biofilm, said source of free available halogen being present in said recirculating water in amounts that are less than biostatic to the biofilm.

2. The method of claim 1 wherein the biofilm is produced by at least one biofilm-producing microorganism and the amount of organic matter present in the water is less than 0.1 weight percent.

3. The method of claim 1 wherein the di(lower alkyl) substituted-2-oxazolidinone can be represented by the formula 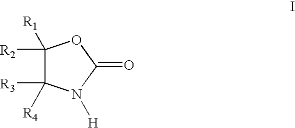
wherein the substituents R₁, R₂, R₃, and R₄ are each chosen from hydrogen and lower alkyl, provided that at least two of R₁, R₂, R₃, and R₄ are lower alkyl groups.

4. The method of claim 3 wherein the di(lower alkyl) substituted-oxazolidinone is 4,4-dimethyl-2-oxazolidinone or 5,5-dimethyl-2-oxazolidinone.

5. The method of claim 1 wherein the source of free available halogen is chosen from free halogen, hypohalous acid or hypohalite ion.

6. The method of claim 5 wherein the source of free available halogen is chosen from chlorine, hypochlorous acid or hypochlorite ion, and the hypochlorite ion is supplied from alkali metal or alkaline earth metal hypochlorites.

7. The method of claim 6 wherein the source of free available halogen is hypochlorite ion, which is supplied by calcium hypochlorite, and the di(lower alkyl) substituted-oxazolidinone is 4,4-dimethyl-2-oxazolidinone.

8. The method of claim 1 wherein the mole ratio of free available halogen to di(lower alkyl) substituted-2-oxazolidinone ranges from 0.1:1 to 110:1.

9. The method of claim 7 wherein the mole ratio of free available chlorine to di(lower alkyl) substituted-2-oxazolidinone is from 0.5:1 to 1.2:1.

10. The method of claim 1 wherein the source of free available halogen is chosen from chlorine, hypochlorous acid or hypochlorite ion, the di(lower alkyl) substituted-oxazolidinione is 4,4-dimethyl-2-oxazolidinone or 5,5-dimethyl-2-oxazolidinone, and the mole ratio of free available halogen to di(lower alkyl) substituted-2-oxazolidinione ranges from 0.5:1 to 5:1.

11. A method of inhibiting the growth of biofilm on the internal surfaces of an open recirculating water system, wherein the water comprising said water system is substantially free of organic matter that fosters the growth of biofilm-producing microorganism, which method comprises supplying to said recirculating water at least a biostatic amount of 3-halo-di(lower alkyl) substituted-2-oxazolidinone.

12. The method of claim 11 wherein the 3-halo-di(lower alkyl) substituted-2-oxazolidinone can be represented by the following formula: 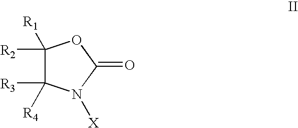
wherein X is chlorine or bromine, and R₁, R₂, R₃, and R₄ are each chosen from hydrogen and lower alkyl, provided that at least two of R₁, R₂, R₃, and R₄ are lower alkyl groups.

13. The method of claim 12 wherein the water comprising the water system contains less than 0.1 weight percent organic matter that fosters the growth of biofilm-producing microorganism and the 3-halo-di(lower alkyl) substituted-2-oxazolidinone is 3-chloro-di(lower alkyl) substituted-2-oxazolidinone.

14. The method of claim 13 wherein the 3-chloro-di(lower alkyl) substituted-2-oxazolidinone is 3-chloro-4,4-dimethyl-2-oxazolidinone.

15. The method of claim 14 wherein the 3-chloro-4,4-dimethyl-2-oxazolidinone is present in the water comprising the water system in amounts of from 0.1 to 100 ppm.

16. The method of claim 15 wherein the water comprising the water system contains less than 0.05 weight percent organic matter, and the 3-chloro-4,4-dimethyl-2-oxazolidinone is present in the water comprising the water system in amounts of from 0.5 to 50 ppm.

17. A method of inhibiting biofouling in an open recirculating water system, wherein the water comprising said water system is substantially free of organic matter that fosters the growth of biofilm-producing microorganism, which method comprises providing in said recirculating water (a) a source of free available halogen and (b) a source of di(lower alkyl) substituted-2 oxazolidinone, the mole ratio of (a) to (b) and the combined amount of each of (a) and (b) being sufficient to inhibit the growth of biofilm in said recirculating water, said source of free available halogen being present in said recirculating water in amounts that are less than biostatic to the biofilm.

18. The method of claim 17 wherein the source of free available halogen is chosen from chlorine, hypochlorous acid or hypochlorite ion, the hypochlorite ion is supplied from alkali metal or alkaline earth metal hypochlorites, the di(lower alkyl) substituted-oxazolidinone is 4,4-dimethyl-2-oxazolidinone or 5,5-dimethyl-2-oxazolidinone, and the mole ratio of free available halogen to di(lower alkyl) substituted-2-oxazolidinone ranges from 0.5:1 to 5:1.

19. The method of claim 18 wherein the combined amount of (a) and (U) present in said recirculating water is at least a biostatic amount.

20. The method of claim 18 wherein the combined amount of (a) and (b) present in said recirculating water is a biocidal amount.
